(19) United States
(12) Patent Application Publication
(10) Pub. No.: US 2019/0190774 A1
(43) Pub. Date: Jun. 20, 2019

(54) NETWORK CONNECTIVITY MONITOR

(71) Applicant: Krishnamurty Kambhampati, Holmdel, NJ (US)

(72) Inventor: Krishnamurty Kambhampati, Holmdel, NJ (US)

(21) Appl. No.: 15/920,773

(22) Filed: Mar. 14, 2018

Related U.S. Application Data
(60) Provisional application No. 62/472,003, filed on Mar. 16, 2017.

(51) Int. Cl. H04L 12/24; H04L 12/26

(52) U.S. Cl. CPC H04L 41/0681; H04L 43/10; H04L 41/22; H04L 43/0835; H04L 41/28; H04L 43/16; H04L 41/069; H04L 43/0811; H04L 43/0858

(57) ABSTRACT

Embodiments of the invention provide a device and method for continuous tracking of the performance of an internet or other network connection and maintaining an inventory of devices connected to the network, while preserving user privacy and security and avoiding modifications to the network infrastructure. A support system is also described comprising modules for reporting, analyzing historical data, and alerting users to problematic network conditions.

### PRIORITY CLAIM

This application claims priority to U.S. Patent Application No. 62/472,003, filed Mar. 16, 2017 and titled, “NETWORK CONNECTIVITY MONITOR,” the contents of which is incorporated by reference in its entirety.

### BACKGROUND

Use of broadband internet has grown in the United States, doubling from just over 50 million subscriptions in 2005 to over 100 million subscriptions in 2015. See http://www.itu.int/en/ITU-D/Statistics/Pages/stat/. The United States is not alone in its hunger for high speed internet access, with France, South Korea, Germany, the U.K., Canada, Brazil, Japan, Switzerland, and China each having broadband penetration rates in excess of 30%. Because of the integration of the internet into our daily lives—through e-commerce, online banking, social networking, and digital media—the amount of raw data consumed is staggering and increasingly burdensome on network infrastructure. A recent Nielsen study calculated that Americans in the 18-24 age bracket consume more than 14 GB of data each day via Wi-Fi—exclusive of mobile data. See http://www.nielsen.com/us/en/insights/news/2016/what-drives-data-usage.html.

But despite this widespread usage and integration into our daily lives, consumers are largely oblivious to the complexity of the global public internet, and are by design shielded from the intricacies of routers, IP addresses, subnet masks, and the like. Consumers may detect a drop in speed or latency, but have no idea what is causing the dip in performance or how to remedy the issue.

With scarcely two-thirds of home consumers expressing satisfaction with their internet service, according to a 2015 poll, the limited information on the actual performance of their networks can limit the consumer in evaluating whether their service is performing well. See https://www.cnet.com/news/cable-providers-isps-see-big-drops-in-customer-satisfaction/. Where service appears to be poor in the eyes of the consumer, it may be difficult to know if lack of internet connectivity or poor performance is due to the home network (including rogue devices that have joined and are consuming bandwidth), the computing device itself, the service provider, the connection from the home to the service provider, or something else.

Devices to monitor and report on a home network have been proposed, but many of these devices require specialized knowledge of network infrastructure, and may not be suitable for the average home user. Other devices require not only specialized knowledge, but require changes to the home networking setup—including the router—which can be daunting for many users, and also introduce the possibility that a user's changes could further impair the network or introduce a security vulnerability.

Software has also been proposed for monitoring network performance, but installing software on the very device that may be responsible for the network problems can cause further complications. Viruses, spyware, malware, and other issues negatively impacting the user's computer device could spread to the monitoring system residing on the same device.

Similarly, devices connected directly to a network that have access to user data—particularly a home internet connection—may pose a privacy concern and may be undesirable to users wary of attaching device that has access to each and every packet of data transmitted over the network, which may contain sensitive financial and personal information.

Other systems for testing network performance, such as web-based systems for measuring latency and bandwidth, utilize external servers, making it impossible to isolate issues present at the immediate location.

What is thus needed is a device for monitoring network performance that requires no specialized networking knowledge, and requires no changes to the home router.

What is further needed is a secure system that can sit behind a home router or firewall while conducting testing, without changes to the network infrastructure.

What is further needed is a system that is able to identify network issues in a location, and to isolate those issues from the network at large.

What is further needed is a system that preserves network security by not requiring any changes to the network in order to operate.

What is further needed is a system for monitoring network health and performance that is independent of the devices attached to the network.

What is further needed is a system that maintains the privacy of user data by not having access to that data as part of the testing and monitoring protocol.

What is further needed is a system that notifies and alerts of network irregularities visually through the display or through other notification methods such as email, SMS or in-app alerts.

### BRIEF DESCRIPTION OF THE DRAWINGS

The features and advantages of the present disclosure will be more fully understood with reference to the following detailed description when taken in conjunction with the accompanying figures, wherein:

FIG. 1a illustrates an embodiment of a network connectivity monitor.

FIG. 1b illustrates an alternate view of the network connectivity monitor of FIG. 1.

FIG. 2 is a flowchart describing an exemplary usage scenario practiced by embodiments of the invention.

FIGS. 3a-3c illustrate three different status conditions utilized in embodiments of the invention.

FIG. 4 is a flowchart describing in detail an exemplary boot sequence practiced by embodiments of the invention.

FIG. 5 is a flowchart showing a sample interval and testing cycle practiced by embodiments of the invention.

FIGS. 6a-6b show the results of a sample network scan and configuration log utilized with embodiments of the invention.

### SUMMARY

The exemplary embodiments of the present include a network monitoring device configured to monitor network health and availability is described, comprising a communication interface for establishing communication with at least one network device; a user notification module configured to provide alerting to a user and a processing element. In embodiments, the processing element is configured to cause the network monitoring device to: (a) transmit a data packet to a central performance server via the at least one network device, the data packet containing a unique identifier; (b) wait a predetermined interval for a responsive data packet; (c) if a responsive data packet is received, calculate an elapsed time between the sent data packet and responsive data packet to generate a performance metric, and communicate the performance metric to the central performance server; and (d) if a responsive data packet is not received, calculate whether to activate the user notification module.

A method of monitoring device network health and utilization is also disclosed, comprising: providing a network monitoring device configured substantially as described in the foregoing paragraph. In embodiments, the method may include the additional steps of: (a) providing a database subsystem in communication with the central performance server; (b) aggregating a plurality of performance metrics received from the network monitoring device and storing the performance metrics in the database subsystem; and (c) providing a notification to the user when the performance metrics are outside a predetermined threshold.

In embodiments, the data packets transmitted to the central performance server may occur on a periodic or non-periodic schedule.

In embodiments, the network monitoring device is configured to collect an identifier from each device connected to a local network and transmit that identifier to the central performance server.

In embodiments of the invention, the performance metric includes one of: elapsed time, packet loss, packet delay, and packet sequence, and may be generated using data from the transmission of the data packet between the network monitoring device and the central performance server, and return.

In embodiments, a communication interface may provide a wired connection between the network monitoring device and a home router or modem. Power to the network monitoring device may be provided via a USB connection with the home router or modem.

In embodiments, the user notification module is a display on the network monitoring device, which may be configured to provide a change in color indicative of a network condition.

### DETAILED DESCRIPTION

A system and method are described for continuous monitoring of a connection to a computer network such as the internet, and the connectivity of devices associated with the network, to troubleshoot performance and connectivity issues without accessing user data or making changes to any customer connectivity or routing (even if temporarily or for a certain period of time). In embodiments of the invention, an automated, user-independent, standalone, continuous, geographically diverse, privacy-aware monitoring system is provided with a continuous status display to assist with troubleshooting, problem segmentation and isolation, interpretation based on history and current automated testing.

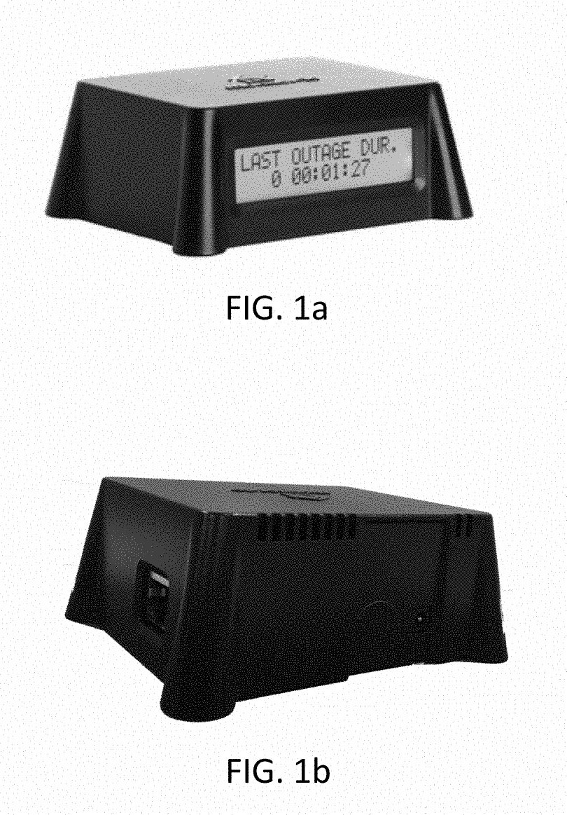

In embodiments, a monitor comprises a portable standalone unit with an integrated display that may be connected to the network as a device. Referring to FIGS. 1a-1b, a prototype embodiment of a monitor is shown. As will be described below, housing may contain a single-board computing device that is utilized to direct and perform the communications, testing, and reporting functions of the system. Historical data can be used to generate reports.

Functionality related to network testing, reporting, and system operation may be provided by custom software loaded or pre-loaded on the monitor, in communication with one or more external servers. In embodiments, a Linux kernel operating system may control the device and interact with software residing on one or more remote servers, while software on the one or more external servers may perform logical inference based on the data to produce notifications to the user.

### Out of the Box Overview

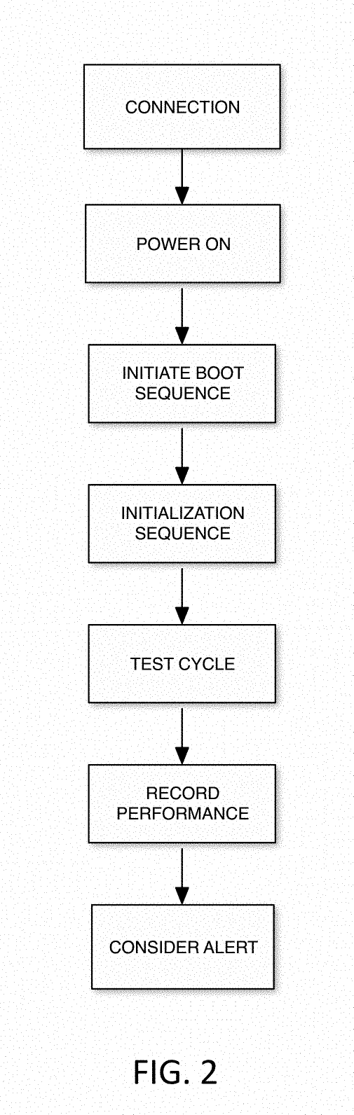

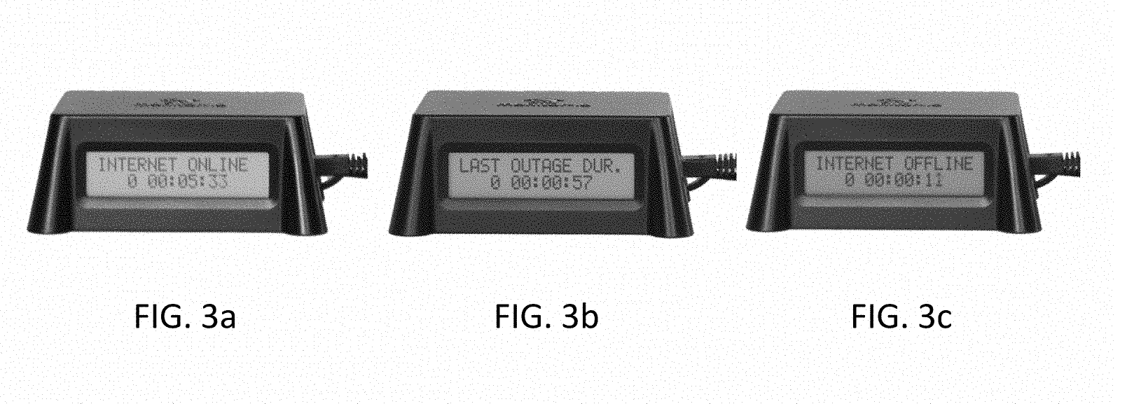

An overview of the functioning of an exemplary system will now be described, as illustrated by FIG. 2, which describes an exemplary usage sequence. After the device is connected to an available port on the router, the device may be powered on, and the boot sequence (described in more detail in FIG. 3) initiated. A series of initialization steps may then be performed to, for example, make connections to remote servers, verify the availability of testing tools, and other functions. A first testing cycle may then be as described below, after which performance metrics may be recorded. After a latency interval, subsequent testing cycle may be initiated and recorded. Whether or not an alert should be presented to the user is then determined. This latency-testing-recordation cycle may be repeated indefinitely, or for a prescribed time interval.

### Hardware

The hardware used with embodiments of the invention will now be described in greater detail. As shown in FIGS. 1a-1b, a housing may be provided for supporting the computing elements of the system, along with indicator display(s), and input/output ports.

In embodiments, a single-board computing device (“SBC”) may be used to provide the processing and communication functions of an exemplary system. The SBC provides an integrated, low-cost set of system electronics such as a microprocessor, memory, input/output system, and power supply, and has been found to be suitable for use with embodiments of the present invention. A vast variety of SBC devices are commercially available and the selection of a particular SBC may be tailored depending on a balance of cost, size, and performance characteristics.

A prototype of an embodiment of the invention was created using an Orange Pi One open-source single board computer supplied by Shenzhen Xunlong Software Co., Ltd. This particular device has a H3 Quad-core Cortex-A7 H.265/HEVC 4K processor and 512 MB of DDR3 memory, which has been found to be sufficient for supporting the software described herein and managing the testing protocol described below. A TF or SD card slot capable of accepting cards up to 64 GB was also provided, along with a 10/100M Ethernet RJ45 port, a USB 2.0 port, and DC power supply, among other features. The 69 mm×48 mm footprint of the device was found to be suitable for use in a home environment and would not be so large when seated in a housing that it would be visually unappealing to home users.

In embodiments, a plurality of ports may be provided in housing for interconnection to external devices. A 10/100Base-T Ethernet/RJ-45 connection may be provided for connecting the system electronics to a home router to perform testing and analysis. A power supply may be provided for connecting to a wall outlet or USB power supply. Depending on the intended application and feature set, various other ports and connectors may be provided such as readers for flash memory devices to allow for external data to be loaded to the device. In embodiments, software updates or additional features may be implemented via data loaded through a USB or flash memory connection. In further embodiments, reporting or testing data may be downloaded from the device via these ports.

A display may be connected to the SBC in the housing for reporting error conditions and other information to the user. An exemplary display is shown in FIG. 1 in the form of a two-line backlit liquid crystal display measuring approximately 1″×3″ and capable of displaying two lines of 16 characters each. As will be discussed below, a variety of system messages and data may be shown on the display.

In embodiments, display may be colored or contain a colored backlight to indicate overall system status. FIGS. 3a-3c show three exemplary status conditions.

Referring to FIG. 3a, a satisfactory status condition is shown. “INTERNET ONLINE” indicates that the internet connection is active, and the timer below the text indicates the length of time that the connection has been in this state. In embodiments, the display may be backlit in green to indicate this condition.

FIG. 3b shows a condition where there has been a performance issue or a recent outage. FIG. 3b shows an intermediate condition that, in embodiments of the invention, may be backlit in purple.

FIG. 3c shows a condition where there is a no connectivity to the internet, along with a running timer showing the duration of the outage. In embodiments, the display may be backlit in red to indicate this condition and draw attention.

In embodiments, colored LEDs may take the place of (or be used in conjunction with) the display to indicate a status condition. In further embodiments, graphical symbols or text on the housing may be backlit by LEDs to indicate a status condition. It will be understood that the display function is not limited to any particular style of display or type of light and is limited only by the information that must be conveyed to the user.

In embodiments, a housing may be provided to securely contain the SBC and display, and to provide a sleek and compact form factor. Housing may be formed with openings for the various ports and/or status indicators, depending on the configuration of the SBC and display.

Housing may be formed from any material that is durable and can readily be formed, molded, or shaped to meet the desired application. Examples include polymers, wood, ceramic, silicone, and metal, among others. In embodiments, housing may be colored or textured to provide visual appeal, or may be configured to mimic the outward appearance of a home router, or to fit atop or adjacent the router using a complementary shape. In embodiments, external décor elements on housing may be removable or interchangeable.

It should be noted that the physical characteristics of the monitor may vary from FIG. 1, including the dimensions, port arrangement, display size and position, and so forth.

In embodiments, additional components may be provided for extending the functionality of the system, whether integrated with the SBC or as separate components. For example, wireless networking or wireless data transfer may be provided, with connections for Wi-Fi, Bluetooth, NFC, and other wireless communication protocols, which may be provided to transfer data from the monitor to remote servers or local computing devices. In a preferred embodiment, the connection between the monitor and the network may be wired even in the presence of a wireless connection for other purposes such as reporting or setup.

### Preconfiguration

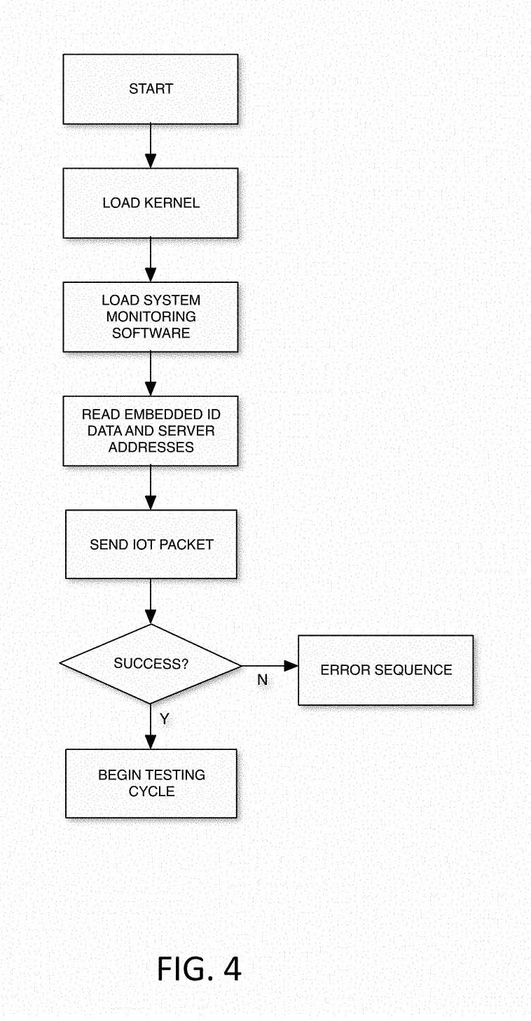

FIG. 4 contains a flowchart describing a sample boot and initialization sequence and startup. Upon power-up, the system may load the system kernel which, in embodiments, may be a LINUX kernel that manages startup, handles low-level input-output requests, manages memory and communications with any external devices and servers.

System kernel may also load the system monitoring software that monitors system status, coordinates system testing functions, collects and aggregates data, and interacts with the one or more remote servers.

In embodiments, monitor may be factory pre-loaded with data relative to the identity of the device and the location of resources that may be available for system testing. For example, in embodiments, monitor may be provided with a unique media access control (“MAC”) address, a unique identifier that identifies the device on the network. In embodiments, system may read its MAC address as part of its startup sequence as it connects to the network. Alternatively, a unique identifier may be provided by the system to identify each user, which identification may be independent of any single physical device and instead be associated with a single user profile.

In embodiments, the system may also be pre-loaded with a network DNS name for an IoT management server or the network DNS name for the performance servers (described below) configured to collect and process statistics on system performance. This identification and server data may be permanently assigned to the device and embedded in a read-only memory (ROM) or may be dynamic and adjustable via a network connection, or by loading data onto the device through a built-in port or connection.

Following successful loading of the system kernel and software, and reading the ID and server DNS names, embodiments of the system may then attempt to send a signal to a central server known as an IoT server. In embodiments, an IoT server may aid the service provider in managing the inventory of devices connected and operating, coordinate the two-way sharing of device data, and other functions. As part of the IoT management framework, at the most basic level, a connected monitor may periodically send a signal (colloquially known to as a “heartbeat” or “pulse”) identifying the device and indicating that it is in operation. The frequency and regularity of these signal may indicate to the IoT server whether a monitor is still connected, or whether it has encountered an error condition.

In embodiments, upon the initiation of a testing cycle, monitor may send a periodic signal to the IoT servers to confirm that it is still active and connected to the network. In embodiments, IoT servers may hold responsibility for maintaining the inventory of numerous monitors across the Internet, verifying that they remain active and online, facilitating data transfer, and the like. The periodic signal allows a monitor to confirm that it is online and has not suffered an error such as a software or hardware failure. The periodic signal allows a monitor to remain connected even when the testing interval of the individual monitor is greater than the minimum “check-in” period set by the IoT servers.

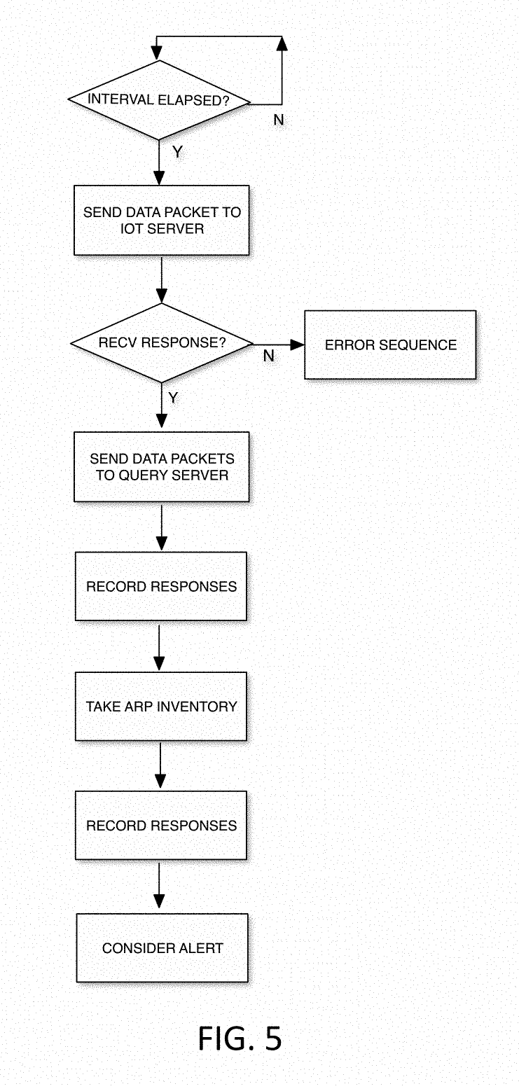

On confirming that the initialization sequence has successfully completed, the monitor will commence normal operation. FIG. 5 shows a flowchart describing normal monitoring operation of the system.

### Testing Cycle

In embodiments, a test cycle may comprise several steps that can be summarized as: (1) performance measurement; (2) connectivity verification; and (3) device inventory.

In embodiments, testing cycles may be distributed between time intervals so as to provide timely data and sampling and rapid error detection, while also minimizing disruption or load on network infrastructure. In embodiments, testing intervals may be pre-set by the system or defined by the user. Too frequent testing may run the risk of placing an additional burden on the network and degrading performance, while testing that is too infrequent runs the risk of missing errors.

Referring to FIG. 5, the sample interval and testing cycle is described. The monitor may first check to see if the current interval between cycles has lapsed. If no, the monitor continues to wait before initiating the next testing cycle. If yes, control moves to the following step.

It has been found that using a non-periodic testing interval can be advantageous in identifying network errors that occur at a relatively fixed time interval such as, for example, network retry issues than can take a periodic characteristic and might be missed in a periodic testing interval. A doubly-truncated Poisson function has been used to generate a series of random numbers with an average lambda—or expected value—of 10 seconds. Unlike setting an interval of a fixed 10 seconds between testing cycles, the results of the Poisson function can provide a stream of statistically distributed intervals that as a whole average 10 seconds, but with individual time intervals varying from cycle to cycle. Such a configuration allows for non-periodic testing while also keeping the average cycle interval close to the desired average. The upper bound truncation ensures that long periods do not pass without testing.

The monitor may next send a data packet to the IoT server to confirm to the IoT server that the monitor is active and that a connection is present. In embodiments, data packet may include identifying information that authenticates the monitor to the IoT server, such as MAC address or a unique ID code generated for use within the system. Monitor may then wait for a responsive data packet for up to a predetermined interval. If no response is received from the IoT server, an error sequence may be initiated. Control may then move on to the next testing sequence.

In embodiments, a subsequent testing sequence may examine network health, by transmitting a query to one or more query servers attaching a data packet. The query server may then return a response that allows the system to calculate the time for a single probe to travel to the remote server, and return. Multiple probes may be sent as part of a single testing cycle, enabling the system to record an average round-trip time, along with the number of data packets lost in the transmission-response cycle. The query function may be implemented in the system software loaded onto the device, using a complex set of test-packet interactions using protocols such as UDP with the ability to embed timestamps and sequence numbers to determine directional impairments or a conventional networking protocol such as ICMP may be used.

If one or more queries return data from the remote server, the data packets returned are read and the performance metrics are calculated, including average time and percentage loss. This data may then—with the aid of the IoT server—be reported to the remote database with a timestamp.

In embodiments, rather than a separate data packet, the query server step may be integrated with the IoT server check-in, with a single data packet completing the steps of checking in with the IoT server, and also measuring the round-trip time.

Data from the testing cycle may be aggregated in a database and analyzed on a remote server to calculate detailed performance metrics. In embodiments, the system may track various data points and performance metrics, including:
a. elapsed time for all testing cycles;
b. number of testing cycles;
c. number and percentage of packets lost;
d. number and percentage of packets delayed;
e. delay time;
f. number and percentage of packets out of order;
g. number and percentage of individual test with impairments;
h. number and percentage of individual test with no impairments;
i. number of and percentage of outages; and
j. total outage time.

In embodiments, statistics may be compared with a threshold defined by the system or the user and a determination made as to whether an alert is warranted.

In embodiments, reports may be generated for the user on a periodic basis, or dynamically in response to requests, and presented to the user on a separate computing device such as tablet computer.

As a final part of an exemplary testing cycle an inventory of devices connected to the network may be taken and compared with the inventory at an earlier timestamp. The difference in device inventory will indicate which devices have joined or departed the network.

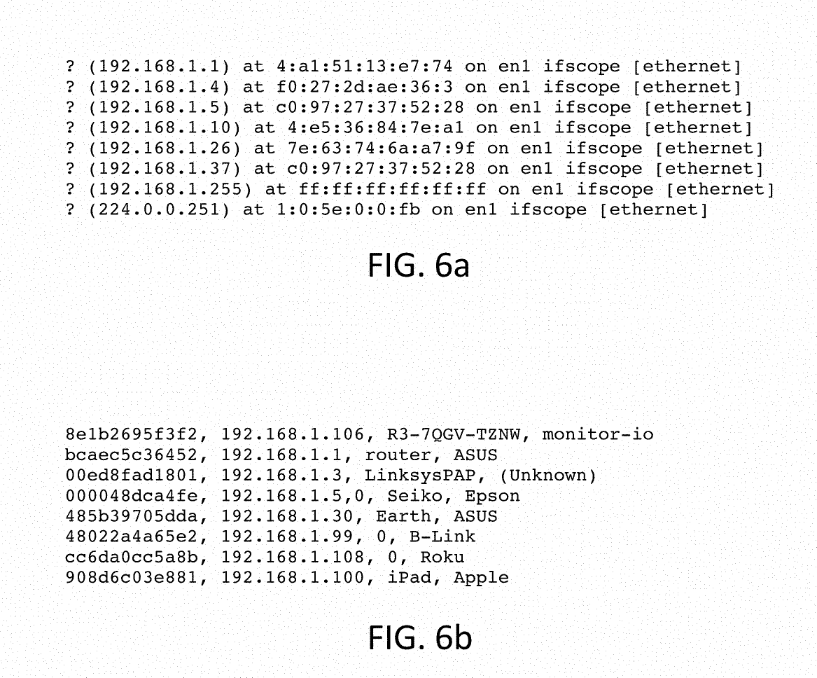

As shown in FIG. 6a, monitor may run an address resolution protocol (“ARP”) for each address on the local network (LAN). The ARP reply returns the MAC address associated with the IP address queried. The MAC address is associated with a particular manufacturer, so the manufacturer of the device may also be identified, for example to recognize an “Apple” “Epson” or other such manufacturer as a hint to the user.

In embodiments, a scan may transmit a request to all devices connected to a network soliciting a response with the respective MAC and IP address of each device. A reverse DNS lookup may also be performed on each IP address in order to obtain any name assigned to the device. The results of an exemplary ARP scan without DNS resolution is shown in FIG. 6a and with DNS resolution in FIG. 6b.

Similar to the query server above, the ARP scan broadcasts a signal to the network soliciting responses from each device connected at the time of the scan. In embodiments, an ARP scan may retrieve the MAC address and IP address of each device connected to the network, which information is recorded in the database along with a timestamp.

Returning to FIG. 6a, once the ARP scan has completed and the device log updated, the system returns information on performance tests and ARP back to database. A record of all devices joining the network over time may be generated and utilized to prepare dynamic alerts to the user (e.g., by e-mail, SMS, etc.). In embodiments, a user may opt-in to a notification whenever a new device (as determined by the MAC address) joins the network. In further embodiments, a whitelist or blacklist may be provided for specific devices to control access to the network.

In embodiments, a user may be given the option to show devices joining the network over a time interval, or to prepare activity reports using custom criteria.

As shown above, network performance, and an inventory of all devices joining and departing the network can be obtained without any access to confidential or private data or any adjustments to the network setup.

### Reporting

As discussed above, a wide range of reporting features and methods are contemplated as coming within the scope of the invention. Collection of data from the various testing and scanning steps may be aggregated and used to prepare rich and dynamic reports to the user, and to measure when an alert should be indicated.

In embodiments, a variety of alert mechanisms may be utilized. In embodiments, a physical display on the monitor may provide summary information concerning network health to the user. For example, as shown in FIG. 3b, display may show the time elapsed since the last network outage. A multicolor display may also be provided to indicate, in addition to performance data on the display, a one-glance summary of network health as indicated by the color. For example, if all performance tests have no impairments and a signal is received then a green display will be shown. Alternatively, if at least one performance test showed an impairment or the connection to the IoT server is lost, a color indicating an intermediate concern (e.g., magenta, amber, orange) will be shown. Lastly, if no performance data was obtained during the most recent testing cycle, and the connection to the IoT server has been lost, then a red display will be shown.

### Feature Summary

In summary, features of exemplary embodiments of the present invention may include:
a. An ability to monitor the connectivity of devices on the home network.
b. The ability to provide notification when the Internet connection is unavailable.
c. The ability to provide historical data on the quality of the Internet connection over time.
d. The ability to provide historical connectivity profiles of identified devices within the home
e. The ability to provide notification on the addition of a new device connecting to the home network.
f. The ability to provide notification when an essential device is no longer connected to the home network.
g. The ability to provide historical activity of devices connected to the home network.
h. The ability to provide notification when a device connects to the home network in a proscribed time period.
i. The ability to refine the performance of any device within the home using the test-point to improve positioning with respect to the home network Wi-Fi antenna.
j. The ability to install the device in a remote location and monitor the health of the Internet connection remotely.

It will be understood that there are numerous modifications of the illustrated embodiments described above which will be readily apparent to one skilled in the art, such as increasing or decreasing the number of packets used for testing, the protocol of the tests used, the size of the packets, the type of testing, embedding timestamps and other information in the test packets, changing the notification triggers, and any other combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A network monitoring device configured to monitor network health and availability, comprising:
a communication interface for establishing communication with at least one network device;
a user notification module configured to provide alerting to a user;
a processing element configured to cause the network monitoring device to: (a) transmit a data packet to a central performance server via the at least one network device, the data packet containing a unique identifier; (b) wait a predetermined interval for a responsive data packet; (c) if a responsive data packet is received, calculate an elapsed time between the sent data packet and responsive data packet to generate a performance metric, and communicate the performance metric to the central performance server; and (d) if a responsive data packet is not received, calculate whether to activate the user notification module.

2. The network monitoring device of claim 1 wherein the processing element is further configured to collect an identifier from each device connected to a local network and transmit that identifier to the central performance server.

3. The network monitoring device of claim 1 wherein the performance metric includes one of: elapsed time, packet loss, packet delay, and packet sequence.

4. The network monitoring device of claim 3 wherein the performance metric is generated using data from the transmission of the data packet between the network monitoring device and the central performance server, and return.

5. The network monitoring device of claim 1 wherein the communication interface is a wired communication interface to provide a wired connection between the network monitoring device and a home router or modem.

6. The network monitoring device of claim 5 wherein the network monitoring device is further configured to receive power via a USB connection with the home router or modem.

7. The network monitoring device of claim 1 wherein the user notification module is a display on the network monitoring device.

8. The network monitoring device of claim 7 wherein the user notification module is further configured to provide a change in color indicative of a network condition.

9. The network monitoring device of claim 1 wherein the data packets are transmitted to the central performance server on a periodic schedule.

10. The network monitoring device of claim 1 wherein the data packets are transmitted to the central performance server on a non-periodic schedule.

11. A method of monitoring device network health and availability, comprising:
providing a network monitoring device configured to: (a) transmit a data packet to a central performance server via the at least one network device, the data packet containing a unique identifier; (b) wait a predetermined interval for a responsive data packet; (c) if a responsive data packet is received, calculate an elapsed time between the sent data packet and responsive data packet to generate a performance metric, and communicate the performance metric to the central performance server; and (d) if a responsive data packet is not received, calculate whether to activate the user notification module;
providing a database subsystem in communication with the central performance server;
aggregating a plurality of performance metrics received from the network monitoring device, and storing the performance metrics in the database subsystem;
providing a notification to the user when the performance metrics are outside a predetermined threshold.

12. The method of claim 11 wherein the network monitoring device is further configured to collect an identifier from each device connected to a local network and transmit that identifier to the central performance server.

13. The method of claim 11 wherein the network monitoring device includes one of: elapsed time, packet loss, packet delay, packet sequence, packet loss over time, packet delay over time.

14. The method of claim 13 wherein the performance metric is generated using data from the transmission of the data packet between the network monitoring device and the central performance server, and return.

15. The method of claim 11 wherein the communication interface is a wired communication interface to provide a wired connection between the network monitoring device and a home router or modem.

16. The method of claim 15 wherein the network monitoring device is further configured to receive power via a USB connection with the home router or modem.

17. The method of claim 11 wherein the user notification module is a display on the network monitoring device.

18. The method of claim 17 wherein the user notification module is further configured to provide a change in color indicative of a network condition.

19. The method of claim 11 wherein the data packets are transmitted to the central performance server on a periodic schedule.

20. The method of claim 11 wherein the data packets are transmitted to the central performance server on a non-periodic schedule.
